(19) United States
(12) Patent Application Publication
(10) Pub. No.: US 2020/0347793 A1
(43) Pub. Date: Nov. 5, 2020

(54) METHOD AND DEVICE FOR CONTROLLING A FILL LEVEL OF A CATALYTIC CONVERTER FOR AN INTERNAL COMBUSTION ENGINE

(71) Applicant: Robert Bosch GmbH, Stuttgart (DE)

(72) Inventors: Alexandre Wagner, Stuttgart (DE); Michael Fey, Wiernsheim (DE)

(21) Appl. No.: 16/962,660

(22) PCT Filed: Dec. 27, 2018
(86) PCT No.: PCT/EP2018/097009

§ 371 Date: Jul. 16, 2020

(30) Foreign Application Priority Data
Jan. 30, 2018 (DE) 10 2018 201 371.3

(51) Int. Cl. F02D 41/02; F02D 41/14

(52) U.S. Cl. CPC F02D 41/0295; F02D 41/1454; F02D 41/1445; F02D 2200/0618; F02D 2200/0814; F02D 2200/701; F02D 2200/101; F02D 41/1446

(57) ABSTRACT

A method and device including an interface, a memory, and a processor for the control of a fill level of a catalytic converter for an internal combustion engine of a motor vehicle. A setpoint variable is ascertained as a function of an expected operating variable for the fill level, and the expected operating variable is determined as a function of information from at least one further sensor, which acquires information about an operating state of the motor vehicle.

### FIELD

The present invention relates to a method and a device for controlling a fill level of a catalytic converter for an internal combustion engine, in particular of a motor vehicle.

### BACKGROUND INFORMATION

German Patent Application No. DE 10 2015 209 820 A1 describes a control of a catalytic converter of an internal combustion engine with the aid of signals from two lambda probes and as a function of operating conditions of the internal combustion engine.

Such catalytic converters are used for the conversion of pollutant emissions. A high conversion rate is achieved by operating the catalytic converter in a conversion window around a stoichiometric operating point, that is to say, at a λ=1 value. For this purpose, a lambda probe is placed on each side of the catalytic converter. These probes measure the lambda value upstream and downstream from the catalytic converter. Depending on the signals from the two lambda probes, the internal combustion engine is controlled in such a way that the catalytic converter is operated in the conversion window.

Because of an oxygen storage capacity of the catalytic converter, the lambda value downstream from the catalytic converter changes only with a delay. As a result, leaving of the conversion window is indicated only too late by the lambda probe downstream from the catalytic converter. Higher emissions may therefore occur.

Therefore, it is an object of the present invention to provide a better control of the catalytic converter.

### SUMMARY

The object achieved by an example embodiment of the present invention.

In accordance with an example embodiment of the present invention, a method is provided for controlling a fill level of a catalytic converter for an internal combustion engine of a motor vehicle, the fill level being controlled as a function of a setpoint variable for the fill level, the setpoint variable being ascertained as a function of an expected operating variable for the fill level, the expected operating variable being determined as a function of information from at least one sensor, which acquires information about an operating state of the motor vehicle. In particular, the example method is used for the control of an oxygen fill level. Signals from one or a plurality of lambda probes are used for determining an actual fill level. The setpoint variable is specified as a function of the expected operating conditions. For example, the setpoint variable may be a setpoint oxygen fill level or a setpoint oxygen fill level profile. In this way, the setpoint fill level is set not only under consideration of the current operating conditions or the developments in the most recent past, but also as a function of expected operating conditions. This makes it possible to avoid leaving the conversion window.

It is preferably provided that a lambda control operates the internal combustion engine in a conversion window around a λ=1 value, an expected oxygen fill level in the catalytic converter being determined as a function of the expected operating variable, and it being checked whether the conversion window would be left at the expected oxygen fill level, and at least one actuator of the internal combustion engine being actuated for influencing the oxygen fill level in the catalytic converter as a function of the setpoint variable. For example, the actuator is developed to influence the fuel quantity and/or the air mass in the internal combustion engine, and thus the residual oxygen content in the exhaust gas. This detects potential leaving of the conversion window in a timely manner and possibly effectively avoids it.

It is preferably provided that the sensor acquires navigation data for the motor vehicle or vehicle environment information. This information makes it possible to make predictions about the future operating state of the internal combustion engine at least briefly for the, for instance, one to five seconds that also correspond to a system delay time due to the oxygen storage capacity of the catalytic converter. A sufficiently accurate forecast for avoiding the leaving of the conversion window is possible in this way.

It is preferably provided that the setpoint variable is a setpoint oxygen fill level or a setpoint oxygen fill level profile. This is a well-suited setpoint variable for existing lambda controls.

The expected operating variable is preferably determined as a function of a current operating condition, an expected operating condition and/or a past operating condition of the internal combustion engine or the motor vehicle and/or as a function of its change. This provides a better model for the expected operating variable. Current operating conditions represent a suitable starting point, and past operating conditions or changes provide a possibility for predicting a trend in the development of the expected operating condition.

It is preferably provided that a measure for a stability of the current operating condition, the expected operating condition and/or the past operating condition is determined, the expected operating variable and/or the setpoint variable being determined as a function of the measure. On this basis, it is possible to derive with a certain degree of probability whether the future conditions remain stable, e.g., for the next one to five seconds.

It is preferably provided that the measure for the stability is determined as a function of multiple acquired values of an operating condition. This improves the accuracy of the prediction of future conditions.

It is preferably provided that an expected operating state is determined based on the information that was acquired by the sensor, the setpoint variable being determined as a function of the expected operating state. This makes it possible to influence the fill level in the catalytic converter for operating states in a reliable manner.

It is preferably provided that the operating variable for an operating mode of the internal combustion engine is determined as a function of at least one of the following items of information about navigation data, distance radar data, camera data, a rotational speed of the internal combustion engine, loading of the internal combustion engine, an exhaust mass flow in an exhaust system of the internal combustion engine, a temperature of an exhaust gas of the internal combustion engine, an injection time for fuel into the internal combustion engine, a trailing throttle deactivation, an operation of the internal combustion engine decoupled from a drive train of the motor vehicle, an operating mode of an electric motor for the motor vehicle, a cylinder or cylinder bank deactivation, an operating mode of the internal combustion engine featuring a single injection or multiple injections. These variables are available in many current motor vehicles as it is and may be used very satisfactorily for the prediction.

In accordance with an example embodiment of the present invention, a device is provided for controlling a fill level of a catalytic converter for an internal combustion engine, in particular for a motor vehicle. The example device includes an interface, a memory and a processor, the device being developed to acquire a first signal and a second signal at the interface, and to control the internal combustion engine as a function of a setpoint variable for a fill level, the memory including instructions which when executed by the processor, cause one of the mentioned methods to be carried out.

Additional advantageous embodiments result from the description below and the figures.

### BRIEF DESCRIPTION OF THE DRAWINGS

FIG. 1 shows schematically, parts of a motor vehicle in accordance with an example embodiment of the present invention.

FIG. 2 shows schematically, steps in an example method for controlling an oxygen fill level of a catalytic converter for an internal combustion engine in accordance with the present invention.

### DETAILED DESCRIPTION OF EXAMPLE EMBODIMENTS

In the description below, the device and the method are described using the example of a three-way catalytic converter of an internal combustion engine for a motor vehicle. The present invention may also be used in other catalytic converters or internal combustion engines.

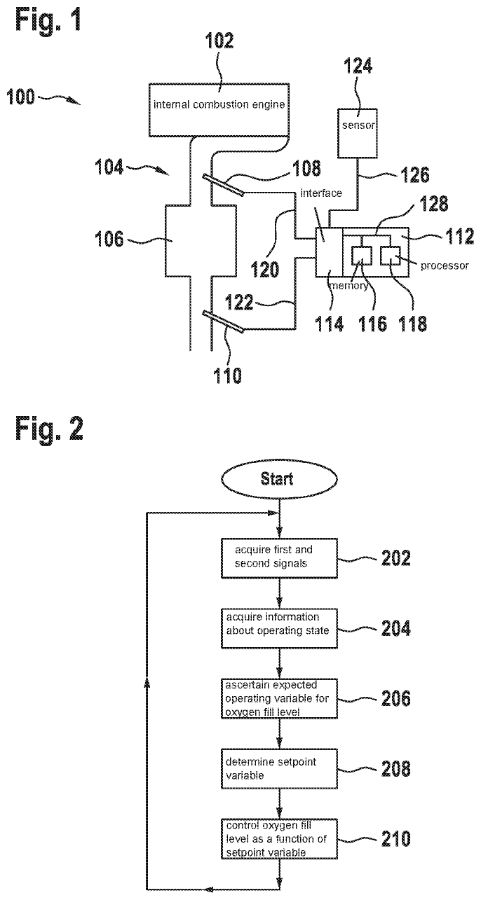

FIG. 1 schematically represents parts of a motor vehicle 100. Motor vehicle 100 includes an internal combustion engine 102 whose exhaust gas is discharged through an exhaust tract 104. A catalytic converter 106 through which the exhaust gas is able to flow is situated in exhaust tract 104. A first lambda probe 108 is situated between an input of catalytic converter 106, via which exhaust gas enters catalytic converter 106, and an input of exhaust tract 104, via which exhaust gas travels from internal combustion engine 102 into the exhaust tract, the first lambda probe acquiring a first oxygen content in the exhaust gas and using it to determine a first signal as information about the first oxygen content. A second lambda probe 110 is situated between an output of catalytic converter 106 and an output of exhaust tract 104 and acquires a second oxygen content in the exhaust gas and uses it to determine a second signal as information about the second oxygen content. For example, the oxygen fill level in catalytic converter 106 is modeled using the first signal and/or the second signal. A model for the oxygen fill level is calculated using the first signal and/or the second signal, for instance.

A device 112 for controlling a fill level, in particular an oxygen fill level, in catalytic converter 106 includes an interface 114, a memory 116, and a processor 118. Device 112 is developed to acquire the first signal and the second signal at interface 114. The first signal is transmitted via a first signal line 120 between first lambda probe 108 and interface 114. The second signal is transmitted via a second signal line 122 between second lambda probe 110 and interface 114. Device 112 is developed to control internal combustion engine 102 as a function of a setpoint variable for the fill level for catalytic converter 106. Memory 116 includes instructions which when executed by processor 118, cause an execution of the example method described below with the aid of FIG. 2. Interface 114 is furthermore developed to receive information from at least one further sensor 124, which is connected to the interface via a third signal line 126. It may also be provided that first lambda probe 108, second lambda probe 110, and/or further sensor 124 is/are connected via a communications bus, e.g., a controller area network or a FlexRay connection. A data bus 128 connects interface 114, memory 116 and processor 118.

The method schematically illustrated in FIG. 2 is based on a lambda control for internal combustion engine 102 by which catalytic converter 106 is able to be operated in a conversion window around a λ=1 value. Depending on the type of the internal combustion engine, an actuator or multiple actuators use(s) the lambda control for a corresponding control of ignition points, injection instants or injection periods, throttle valve angles, opening and closing times of the fuel injectors and the inlet or discharge valves. During the operation in the conversion window, a high conversion rate for hydrocarbon, carbon monoxide and nitrogen oxide is simultaneously possible in the three-way catalytic converter, i.e., catalytic converter 106, in the stoichiometric operating point of the combustion in internal combustion engine 102, that is to say, a λ=1 value. Because of abruptly changing driving situations, the combustion in internal combustion engine 102 must sometimes be changed quite rapidly as well. Due to the oxygen storage capability of catalytic converter 106 and the ensuing related delay time for acquiring the lambda value at the second lambda probe, leaving of the conversion window is detected too late in the conventional lambda control. The control of the oxygen fill level in catalytic converter 106 described below provides a solution.

To control the oxygen fill level of catalytic converter 106, the first signal from first lambda probe 108 and the second signal from second lambda probe 110 are first acquired following the start of the present method in a step 202.

A step 204 is subsequently carried out.

In step 204, the information about the operating state of the motor vehicle is acquired by at least one sensor 124. For example, sensor 124 acquires navigation data for the motor vehicle or vehicle environment information. Sensor 124 acquires obstacles, traffic signs and road conditions, for instance. Sensor 124, for example, may be a distance radar or a camera. On that basis, an imminent braking or acceleration operation, for instance, is able to be calculated in advance. As described in the following steps, the setpoint oxygen fill level of catalytic converter 106 is able to be set in such a way that the probability of leaving the conversion window in the next few seconds is minimized.

A step 206 is then carried out.

In step 206, an expected operating variable for the oxygen fill level of catalytic converter 106 is ascertained. The expected operating variable is acquired as a function of the information about the operating state of motor vehicle 100. For example, the expected operating variable is determined as a function of a current operating condition, an expected operating condition and/or a past operating condition of internal combustion engine 102 of motor vehicle 100 and/or as a function of its change.

In addition or alternatively, a measure for a stability of the current operating condition, of the expected operating condition and/or of the past operating condition is able to be determined. In this case, the expected operating variable may be determined as a function of a measure for a stability of the current operating condition. An evaluation of the stability, for instance, is carried out by comparing a plurality of values, acquired one after the other, for the information about the operating state of the motor vehicle acquired by the at least one further sensor 124. The measure for the stability may also be determined as a function of multiple acquired values of the operating condition.

In addition or as an alternative, an expected operating state is able to be determined based on the information acquired by sensor 124. For instance, additional, predictive vehicle information is acquired on the basis of navigation data and evaluated. This makes it possible to correctly calculate, with a high probability and in advance, a future operating state of motor vehicle 100 or internal combustion 102. As an operating state, an operating mode of internal combustion engine 102 for the next few seconds is able to be calculated in advance. Examples of an operating mode are a gear selection of a transmission in a drive train of motor vehicle 100 or a state of a start-stop function of the internal combustion engine.

Optionally, the operating variable for an operating mode of internal combustion engine 102 is determined as a function of information via navigation data, distance radar data, camera data, a rotational speed of internal combustion engine 102, loading of internal combustion engine 102, an exhaust mass flow in an exhaust system of internal combustion engine 102, a temperature of an exhaust gas of the internal combustion engine, an injection period for fuel into internal combustion engine 102, a trailing throttle deactivation, an operation of internal combustion engine 102 decoupled from a drive train of the motor vehicle, an operating mode of an electric motor for motor vehicle 100, a cylinder or cylinder bank deactivation, an operating mode of internal combustion engine 102 featuring single or multiple injections.

Next, a step 208 is carried out.

In step 208, the setpoint variable is determined as a function of the expected operating variable. Depending on the expected operating variable, an expected oxygen fill level in catalytic converter 106 is determined. For example, the model for the oxygen fill level is calculated for this purpose. In the process it is checked, for instance, whether the conversion window would be left in the next few seconds at the expected oxygen fill level. If this is the case, such as in the event of an expected oxygen excess in catalytic converter 106, a rich mixture is able to be specified for the operation of internal combustion engine 102 with an air deficiency. In an expected oxygen deficiency, it is possible to operate internal combustion engine 102 with a lean mixture for the operation of internal combustion engine 102 with excess air.

If the stability of the operating condition was determined in step 206, the setpoint variable is also able to be determined as a function of the stability. For instance, the setpoint variable is determined independently of the expected operating variable if the stability of the operating condition was detected.

If an expected operating state was determined based on the information acquired by further sensor 124 in step 206, then it may be provided to determine the setpoint variable as a function of the expected operating state.

Next, a step 210 is carried out.

In step 210, the oxygen fill level is controlled as a function of the setpoint variable for the oxygen fill level. For example, the setpoint variable is a setpoint oxygen fill level or a setpoint oxygen fill level profile. Depending on the setpoint variable, for instance, at least one actuator of internal combustion engine 102 for influencing the oxygen fill level in catalytic converter 106 is actuated for the control. The actuator influences the mixture for the combustion in internal combustion engine 102, for instance.

Next, step 202 is carried out.

1-10. (canceled)

11. A method for controlling a fill level of a catalytic converter for an internal combustion engine of a motor vehicle, the method comprising:
ascertaining a setpoint variable for the fill level as a function of an expected operating variable for the fill level, the expected operating variable being determined as a function of information from at least one sensor which acquires information about an operating state of the motor vehicle; and
controlling the fill level as a function of the ascertained setpoint variable for the fill level.

12. The method as recited in claim 11, wherein a lambda control operates the internal combustion engine in a conversion window around a λ=1 value, and an expected oxygen fill level in the catalytic converter is determined as a function of the expected operating variable, and it is checked whether the conversion window would be left at the expected oxygen fill level, and at least one actuator of the internal combustion engine is actuated for influencing the oxygen fill level in the catalytic converter as a function of the setpoint variable.

13. The method as recited in claim 11, wherein the sensor acquires navigation data for the motor vehicle or vehicle environment information.

14. The method as recited in claim 11, wherein the setpoint variable is a setpoint oxygen fill level or a setpoint oxygen fill level profile.

15. The method as recited in claim 11, wherein the expected operating variable is determined as a function of: (i) a current operating condition of the internal combustion engine or the motor vehicle, and/or (ii) an expected operating condition of the internal combustion engine or the motor vehicle, and/or (iii) a past operating condition of the internal combustion engine or the motor vehicle, and/or (iv) a change of the expected operating variable.

16. The method as recited in claim 15, wherein a measure for a stability of the current operating condition, and/or the expected operating condition and/or the past operating condition is determined, and the expected operating variable and/or the setpoint variable is determined as a function of the measure.

17. The method as recited in claim 16, wherein the measure for the stability is determined as a function of multiple acquired values of an operating condition.

18. The method as recited in claim 11, wherein an expected operating state is determined from the information that was acquired by the sensor, and the setpoint variable is determined as a function of the expected operating state.

19. The method as recited in claim 11, wherein the operating variable for an operating mode of the internal combustion engine is determined as a function of at least one of the following items of information about navigation data: (i) distance radar data, (ii) camera data, (iii) a rotational speed of the internal combustion engine, (iv) loading of the internal combustion engine, (v) an exhaust mass flow in an exhaust system of the internal combustion engine, (vi) a temperature of an exhaust gas of the internal combustion engine, (vii) an injection period for fuel into the internal combustion engine, (viii) a trailing throttle deactivation, (ix) an operation of the internal combustion engine decoupled from a drive train of the motor vehicle, (x) an operating type of an electric motor for the motor vehicle, (xi) a cylinder or cylinder bank deactivation, (xii) an operating type of the internal combustion engine featuring single or multiple injection(s).

20. A device for controlling a fill level of a catalytic converter for an internal combustion engine for a motor vehicle, comprising:
an interface;
a memory; and
a processor;
wherein the device is configured to receive information from at least one sensor, and to control the internal combustion engine as a function of a setpoint variable for a fill level, and the memory includes instructions that when executed by the processor, cause the processor to:
ascertain the setpoint variable for the fill level as a function of an expected operating variable for the fill level, the expected operating variable being determined as a function of information from the at least one sensor which acquires information about an operating state of the motor vehicle; and
control the fill level as a function of the ascertained setpoint variable for the fill level.
